(19) United States
(12) Patent Application Publication
(10) Pub. No.: US 2018/0322397 A1
(43) Pub. Date: Nov. 8, 2018

(54) DETECTING CASE FAMILIES WITH ANOMALOUS FREQUENCIES IN RULE-BASED DECISION POLICIES

(71) Applicant: International Business Machines Corporation, Armonk, NY (US)

(72) Inventors: Ulrich M. Junker, Biot (FR); Thierry Kormann, Valbonne (FR)

(21) Appl. No.: 15/588,912

(22) Filed: May 8, 2017

(51) Int. Cl. G06N 5/02; G06Q 10/10

(52) U.S. Cl. CPC G06N 5/025; G06Q 10/103

(57) ABSTRACT

Disclosed embodiments provide techniques for analyzing rule-based decision policies. Data is obtained for a plurality of events. The events can be customer behaviors, or other events that can be interpreted by rules. A rule set is obtained for the plurality of events, where the rule set comprises a plurality of rules. Regions are computed based on the rules within the rule set. Frequency data is computed for the plurality of events, and an indication of frequency density is provided for each region. This allows a user to quickly and easily analyze the effectiveness and appropriateness of the rules as they relate to observed customer behaviors. Recommendations for rule changes can be provided as an output of the disclosed techniques.

### FIELD OF THE INVENTION

The present invention relates generally to analysis of rule-based decision policies.

### BACKGROUND

In a variety of businesses, there can be a need for performance analysis of decision policies on given populations of cases occurring at different time points. For example, a pricing policy may determine a discount for items in a shopping cart in the scope of a given marketing campaign. This campaign may divide the whole population of possible cases in different segments and target a particular segment by a particular discount. In order to be able to evaluate the performance of the decision policy, the decision making behavior of this policy can be monitored and the occurring cases can be registered in a database of historical cases, together with the decisions that have been made for these cases and the time points of when these cases have occurred. Given that information, a business analyst may then want to determine whether the decision policy meets given expectation about frequencies of case occurrences. Thus, there is a need for improvements in the analysis of rule-based decision policies.

### BRIEF DESCRIPTION OF THE DRAWINGS

These and other features of this invention will be more readily understood from the following detailed description of the various aspects of the invention taken in conjunction with the accompanying drawings in which:

FIG. 1 is an illustration of exemplary rule-based visual regions.

FIG. 2 illustrates exemplary input data for rules.

FIG. 3 illustrates a graphical representation of frequency within rule-based visual regions.

FIG. 4 shows a flowchart indicating process steps for identifying regions in a density range in accordance with embodiments of the present invention.

FIG. 5 shows a flowchart illustrating process steps for finding a region in a density range in accordance with embodiments of the present invention.

FIG. 6 shows a flowchart illustrating process steps for computing a region of uniform density in accordance with embodiments of the present invention.

FIG. 7 shows an example of derived nodes during region manipulation.

FIG. 8 shows a flowchart illustrating process steps for computing the derived nodes of a candidate and the candidate region.

FIG. 9 shows an exemplary graphical representation of identified candidates for rule separation and consolidation.

FIG. 10 is a diagram of a system in accordance with embodiments of the present invention.

### SUMMARY

In one aspect, there is provided a computer-implemented method for analyzing rule-based decision policies comprising: obtaining data for a plurality of events; obtaining a rule set for the plurality of events, wherein the rule set comprises a plurality of rules embodied in a computer-based business management system, wherein the computer-based business management system includes a processor; computing frequency data with the processor for the plurality of events based on the rule set; and computing regions based on the rules within the rule set, wherein each region corresponds to a subset of the plurality of events; providing a recommendation of one or more rule modifications based on the frequency data; and rendering the recommendation on a computer display.

In another aspect, there is provided an electronic computing device for analyzing rule-based decision policies, comprising: a processor; a memory coupled to the processor, the memory containing instructions, that when executed by the processor, perform the steps of: obtaining data for a plurality of events; obtaining a rule set for the plurality of events, wherein the rule set comprises a plurality of rules; computing frequency data for the plurality of events based on the rule set; determining a frequency density range for the plurality of events based on the frequency data; computing regions based on the rules within the rule set, wherein each region corresponds to a subset of the plurality of events; providing a recommendation of one or more rule modifications based on the frequency data; and rendering the recommendation on a computer display.

In yet another aspect, there is provided a computer program product for analyzing rule-based decision policies on an electronic computing device, the electronic computing device comprising a computer readable storage medium having program instructions embodied therewith, the program instructions executable by a processor to cause the electronic computing device to: obtain data for a plurality of events; obtain a rule set for the plurality of events, wherein the rule set comprises a plurality of rules; compute frequency data for the plurality of events based on the rule set; determine a frequency density range for the plurality of events based on the frequency data; compute regions based on the rules within the rule set, wherein each region corresponds to a subset of the plurality of events; provide a recommendation of one or more rule modifications based on the frequency data; and render the recommendation on a computer display.

### DETAILED DESCRIPTION

Disclosed embodiments provide techniques for analyzing rule-based decision policies. Data is obtained for a plurality of events. The events can be customer behaviors, or other events that can be interpreted by rules. A rule set is obtained for the plurality of events, where the rule set comprises a plurality of rules. Regions are computed based on the rules within the rule set. Each region is representative of a family of cases (events), and thus corresponds to a subset of the plurality of events. Frequency data is computed for the plurality of events, and an indication of frequency density can be computed for each region. Embodiments allow a user to quickly and easily analyze the effectiveness and appropriateness of the rules as they relate to observed customer behaviors. Recommendations for rule changes can be provided as an output of the disclosed techniques. The recommendations can include recommendations for rule changes involving business practices including, but not limited to, service rates, retail discounts, targeted advertising, and/or product promotions.

As an example, consider the case of analyzing customer purchase habits based on factors of age and purchase value (cart value). In particular, in an online shopping experience, users add merchandise to their “cart” within the online shopping portal for purchase. Business analysts may wish to study the behavior as it relates to age of the customer and value of purchases. For example, there may be segments of customers for which the given discount has not been very attractive, thus leading to a low frequency of cases within those segments. Alternatively, there may be other segments for which the incentive posed by the discount has led to much higher frequency of cases than expected. In both scenarios, the market campaign leader might want to adjust the decision policy in a deliberate way such that it meets expected frequency ranges. Note that while the aforementioned example describes a problem with two dimensions (age and cart value), in general, an N-dimensional problem can be analyzed, where N is greater than two. Additionally, in some embodiments, N can be equal to one.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, integers, steps, operations, elements, components, and/or groups thereof.

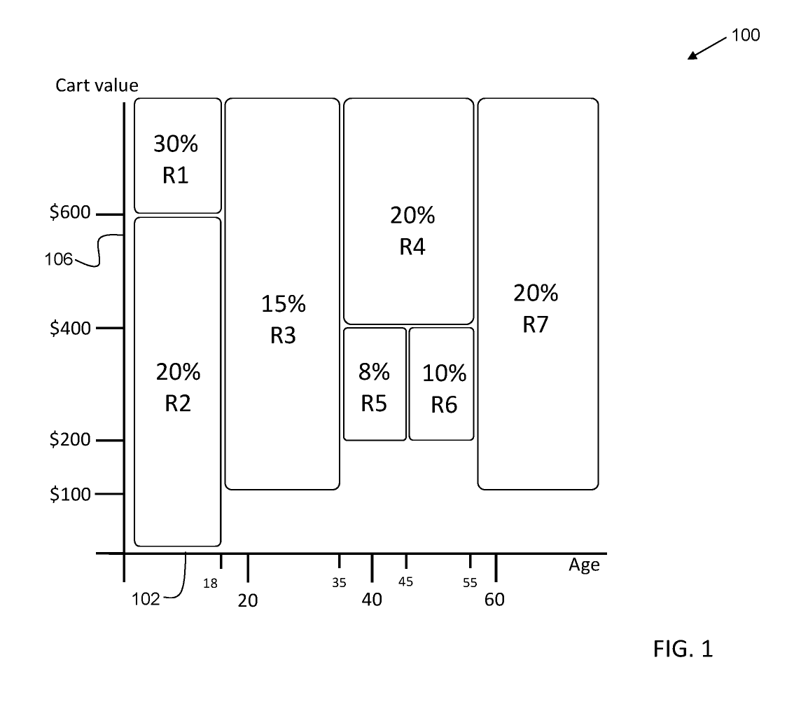

FIG. 1 is an illustration of a graph 100 indicating exemplary rule-based regions. Rule-based decision policies allow modern organizations to process a large volume of cases in a consistent way. For example, a sales organization may launch a marketing campaign and wants to determine a discount for the purchases a customer has made. For this purpose, the organization may use a decision policy that determines this discount for purchases depending on the cart value (i.e., the total amount of the purchases) and the customer age. FIG. 1 illustrates the discount for the different cases that may arise. Each case is characterized by a customer age (indicated by the x-axis 102) and a cart value (indicated by the y-axis 106) and corresponds to a point in the coordinate system spanned by these axes.

The decision policies make the same decision for similar cases. FIG. 1 indicates the families of cases that receive the same discount. These families appear as axe-parallel rectangular regions in the coordinate system that depicts the case space. As a consequence, the discount decision policy can be represented by the following condition-action rules:

Rule r1:

if the customer age is less than 18 and
the cart value is more than $600

then set the discount to 30%;

Rule r2:

if the customer age is less than 18 and
the cart value is less than $600

then set the discount to 20%;

Rule r3:

if the customer age is at least 18 and
the customer age is less than 35 and
the cart value is at least $100

then set the discount to 15%;

Rule r4:

if the customer age is at least 35 and
the customer age is less than 55 and
the cart value is at least $400

then set the discount to 20%;

Rule r5:

if the customer age is at least 35 and
the customer age is less than 45 and
the cart value is at least $200 and
the cart value is less than $400

then set the discount to 8%;

Rule r6:

if the customer age is at least 45 and
the customer age is less than 55 and
the cart value is at least $200 and
the cart value is less than $400

then set the discount to 10%;

Rule r7:

if the customer age is at least 55 and
the cart value is at least $100

then set the discount to 20%;

If a case satisfies the condition of a rule, then the rule is applicable to the case. An applicable rule may be applied to a case by executing the action of the rule. While the discount decision policy defines a discount for all relevant cases, not all these cases may occur during the marketing campaign, whereas other cases may occur several times. In order to evaluate the performance of the decision policy, the organization monitors the submitted cases, the decision that has been made for them, and the rules that have been applied to them. Furthermore, the time points of making the decisions are registered as well.

Hence, the monitoring results in a database of historical cases that have all been decided. Given such a database, it is possible to determine the frequency of cases over the whole time period. It is also possible to determine the temporal distribution of the frequency of cases for a chosen time granularity. For example, the sales organization may determine how often it happened that a 30-year-old customer bought products for an amount of $650. And it may determine how often this happened in each week of the considered time period. For the sake of simplicity, the frequency is not depicted for all cases and different time intervals.

The sales organization may have expectations about the frequency in which the cases should occur. The purpose of the performance analysis is to determine regions of cases for which these expectations have not been met. For example, the marketing campaign might not have incited customers aged between 35 and 55 to buy products in the price range from $200 to $400. If the performance analysis is able to determine regions having a frequency below expectations, the policymaker may change the decision policy in order to make this segment more attractive. There may also be regions having a frequency above expectations. For example, the marketing campaign may have incited more customers than expected to buy products in the price range from $400 and above. Again adjustments of the decision policy may be adequate to meet expectations.

The description above shows that, in general, the performance analysis does not examine the frequency of individual cases, but the frequency of families of similar cases. Those families may be characterized by ranges of values for each attribute of the case such as a range of ages and a range of cart values. These kinds of families delimit axes-parallel rectangular regions in the case space. It should be understood that other kinds of families and other kinds of regions may be considered as well.

The frequency of a family of cases (and thus of the corresponding region in the case space) is the sum of all frequencies of cases within this family. Of course, this frequency grows monotonically with the family. If a family of cases contains another family of cases, then the frequency of the first family is greater than (or equal to) the frequency of the second family. Or, if the frequency is associated to regions in the case space, and if a region contains another region, the frequency of the first region is at least the frequency of the second region. Hence, the frequency will, in general, be dependent on the size of the region.

As such, it is difficult to express expectations on the frequency itself. A business analyst may be more interested in the density of the frequency (i.e., the ratio between the frequency of cases within a region and the total number of possible cases within a region supposing the case space is discrete). As the total number of possible cases within a region of a discrete case space corresponds to the volume of the region, the frequency density is defined as the frequency of cases within a region divided by the volume of the region. This definition works for discrete and continuous case spaces. It can thus be assumed that expectations are expressed in terms of the case frequency density and not the case frequency itself.

As a brief example to illustrate frequency density, consider a marketing campaign that may attribute different discounts depending on the customer age. This may lead to the following frequency distribution among a series of shopping cases: the age of 20 occurred 10 times; the ages 21 to 23 occurred one time each, the ages 30, 38, and 47 also occurred once each, and the other ages did not occur. The purpose is to find regions of cases that occurred rarely. If the performance manager specified a frequency range of 0 and 3, the response may be the region ranging from age 21 to 23 as well as the region ranging from 24 to 47. These two regions have three occurred cases each, but differ in their size and should be distinguished by the performance analysis. The occurrence of cases in the region from 21 to 23 is denser than that in the region from age 24 to 47.

For this reason, the performance analysis should not consider the individual frequencies of the cases in the region, but the density of frequencies of these cases (i.e., the total frequency of cases in the region divided by the volume of the region). For example, the frequency density of the region 21 to 23 is one (each of the three ages occurred once) and that of the region 24 to 47 is 0.125 (there have been only three occurrences of the 24 to 47 ages covered by this region). The purpose of the performance analysis is to determine regions in the case space such that the average frequencies of these regions are in the specified frequency range. Specifying a frequency density range of 0 to 0.2 may thus lead to the selection of the region 24 to 47, but not to the selection of the region 21 to 23. A more complex example of using frequency density to evaluate rule-based decision polices will be further described below.

When combining two disjoint regions, frequencies and frequency densities behave in a rather different way. The frequency of the union of these regions is the sum of the frequencies of these regions, whereas the frequency density of the union is the volume-weighted average of the frequency densities of the two regions. In particular, if the two regions have the same frequency density, then the frequency density of the combined regions will be equal to this frequency density. This property permits the detection of regions with uniform frequency density. Ideally, a region has a uniform frequency density if all sub-regions have the same frequency density as this region. However, it is beneficial to exclude very small regions from this condition as those regions may represent outliers. For example, there may be small spots in the region having an exceptionally low or high frequency. Furthermore, it is possible to consider that a region has a uniform density even if there are small variations of the density among the sub-regions. It therefore is convenient to define uniformity with respect to a density range. A region has a uniform frequency density under a density range if all its sub-regions that exceed a given minimal volume have a frequency density within this range. Thus, embodiments include identifying a region of a uniform frequency density. Furthermore, embodiments can include identifying a region in a specified density range.

It should be noted that the disclosed embodiments will work for other notions of densities as defined above as long as this notion is invariant under the union of regions as described above. For instance, the temporal distribution of cases may be considered, thus adding a further dimension to the regions.

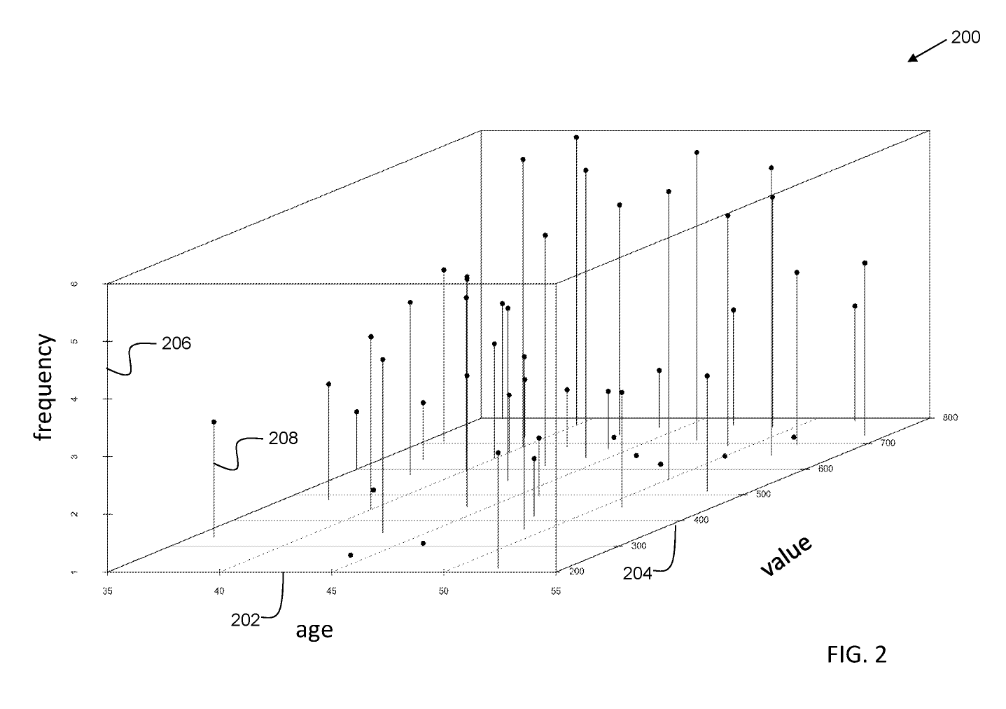

FIG. 2 shows an example 200 of input data for embodiments of the present invention. Axis 202 represents the age of a customer. Axis 204 represents a cart/purchase value. Vertical axis 206 represents frequency. Each data line (indicated generally as 208) represents a frequency of occurrence for a given age and value. The frequency occurrence can be over a predetermined time interval such as a day, week, month, etc. While the example 200 shows a relatively small number of data lines, in practice, with an enterprise system, there can be millions of data lines for a given time interval. As such, visualization of the data in the form shown in FIG. 2 can be extremely difficult, if not impossible, for a human to process directly. Disclosed embodiments provide techniques for detecting how the current rules correspond to observed customer behaviors.

A business analyst may now be interested in finding regions having frequency densities that are anomalously low or high. For both of them, the analyst will define a density range. The analyst may also specify a time period, thus limiting the analysis to historical cases within this time period. The task is to find regions having a uniform frequency density within this density range such that all historical cases in this region have been decided by the same rule. The result is a description of the regions and also reports the rules that have been applied to the cases within these regions. The analyst will thus be able to modify the reported rules for the reported regions.

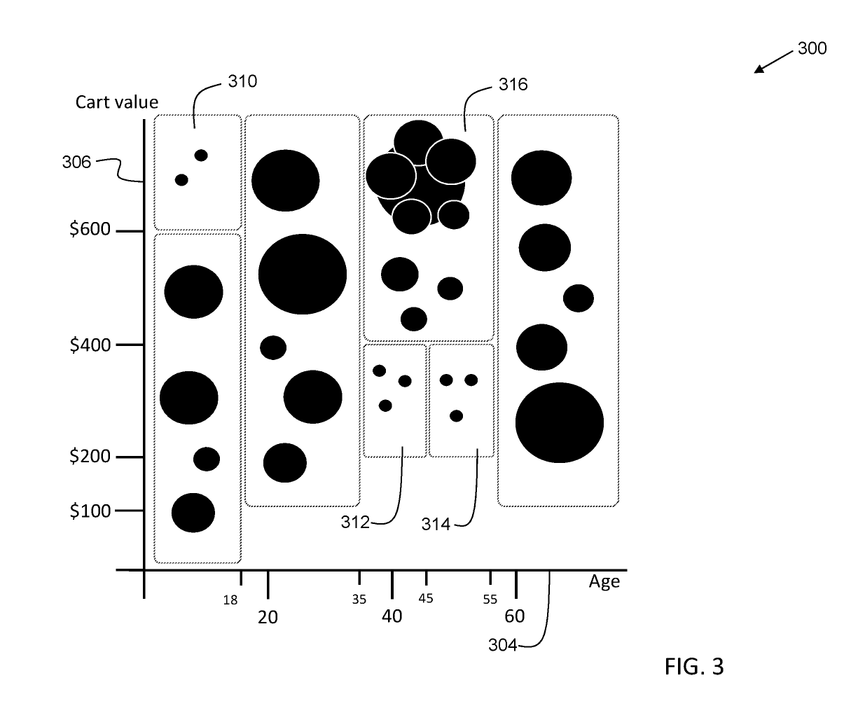

FIG. 3 illustrates a graph 300 showing the frequency density of cases as applied to the discount policy. Graph 300 shows a relationship characterized by a customer age (indicated by the x-axis 304) and a cart value (indicated by the y-axis 306). The frequency density is represented by various sizes of bubbles. Larger bubbles indicate a higher frequency density, whereas smaller bubbles indicate a lower frequency density.

The business analyst may firstly determine regions of low frequency density and specifies a range of 0 to 0.2. In the diagram, this density is indicated by very small bubbles.

A first region 310 includes rare cases for young customers buying items for a large amount. This region is characterized by the following constraints and contains only historical cases that have been decided by rule r1:

a. the customer age is less than 18 and

b. the cart value is more than $600

Indeed, this region contains exactly the cases that may be decided by rule r1. The policymaker may thus modify the action of rule r1 in order to adapt the decision for all these cases. For example, the policymaker may increase the discount in order to make this segment more attractive. Alternatively, the policymaker may opt to redefine the segment.

Two further regions of rare cases are obtained for middle-aged customers who are buying products up to $400 (see the lower center part of Figure “Frequency of purchase cases”). The historical cases in region 312 have been decided by rule r1 and are characterized by the following constraints:

the customer age is at least 35 and

the customer age is less than 45 and

the cart value is at least $200 and

the cart value is less than $400

The historical cases in region 314 have been decided by rule r2 and are characterized by the following constraints:
a. the customer age is at least 45 and
b. the customer age is less than 55 and
c. the cart value is at least $200 and
d. the cart value is less than $400

Indeed, these regions correspond exactly to the cases that may be decided by rule r5 or r6, respectively. As for the previous region, the policymaker may change the discount determined by these rules. If the policymaker chooses the same discount for both regions, the modified versions of rules r5 and r6 could be merged into a single rule. Thus, embodiments include identifying candidates for rule consolidation. In this case, candidate rules r5 and r6 may be consolidated into a single rule.

As illustrated by graph 300, there are no further regions of low frequency density. The business analyst may now determine cases of high frequency density and specify a density range of 0.6 to 1.0. In the graph 300, this density is indicated by larger bubbles.

A region 316 of high frequency density is obtained, and it corresponds to middle-aged customers buying products for more than $600. Region 316 is characterized by the following constraints and contains only historical cases that have been decided by rule r4, which includes the criteria:
a. the customer age is at least 35 and
b. the customer age is less than 55 and
c. the cart value is at least $600

It should be noted that this region does not include all possible cases that may be decided by rule r6. Hence, the description of this region cannot simply be obtained by finding adequate logical combinations of the logical tests of the given rules. It requires an analysis of the data (i.e., the historical cases and the aggregation of these data into regions of uniform density).

Given this region, the policymaker may then decrease the discount made for this region. For this purpose, the policymaker may split rule r4 into two rules. The first one assigns the reduced discount to the cases within the detected region, and the second one assigns the original discount to those cases decided by rule r4 that are outside the reported region. Thus, embodiments include identifying candidates for rule separation.

As illustrated by the last example, the detected regions are characterized by logical tests found in rule conditions, as well as by logical tests that describe boundaries of regions of uniform density. It is the combination of both kinds of tests which distinguishes disclosed embodiments from logical methods of rule analysis on the one hand and empirical methods of data analytics (data mining; statistical analysis; machine learning) on the other hand.

There are two paradigms of methods for extracting information from data, namely analytic methods and synthetic methods. Analytic methods successively divide the given data into groups. The division is achieved by a parameterized classifier which maps the data to groups.

As the classifier is parameterized, different classifications are possible, albeit not all, and the purpose of the analytic method is to determine a suitable classifier among those that are possible. Usually, the analytic method starts with an arbitrary classifier, evaluates how good it classifies each given data element with respect to some given criterion, and then tries to improve the classifier by changing the parameters. It is important to note that data elements are considered independently of each other when evaluating the data elements. Relationships between data elements usually are not considered.

Although analytic methods are highly popular and extremely successful, disclosed embodiments utilize a synthetic method. The synthetic approach includes first establishing relationships (or connections) between data elements, and then successively combining the data elements into groups by following these connections. The method starts with some data element, adds some neighbored data element, and continues growing this group until some termination conditions are reached. It can be ensured that the resulting group satisfies given mathematic properties. For this purpose, it is sufficient to impose constraints on the process that grows the group. In order to meet these constraints, adding a data element to the group may imply the addition of other data elements as well. It should be noted that the growth process is not deterministic. In each growth step, different candidates may be added to the current group and those candidates will be evaluated according to some local criteria.

The synthetic approach leads to the following method for finding regions of historical cases within a specified frequency density range. In the first step, the method will connect historical cases that are neighbors in the case space. The method will aggregate the historical cases into regions based on their connections instead of splitting the case space by a parameterized classifier. It will start with some historical case and grow this seed region by adding connected cases until this results in a region that reaches a minimal volume for evaluating its density. If this density is within the given density range, the disclosed embodiments will grow the current region as long as it stays within this density range. If this density is below (or above) the given density range, the disclosed embodiments will grow the current region as long as it stays below (or above) this density range. This approach guarantees a uniform density by construction as each increment of the region will need to meet the density range. These growth rules thus define which of the historical cases may be combined into a region.

However, there are also rules for separating certain of the historical cases. If two historical cases have been decided by different rules, then the two cases must not belong to the same region. In order to avoid this, connections between historical cases will be labeled as border connections if they connect cases that have been decided by different rules. The disclosed embodiments will not grow the current region across border connections. This guarantees that the constructed regions will contain only historical cases that have been decided by the same rule.

The method thus computes three kinds of regions, namely those that are below, within, and above the specified density range. Once the method has computed a region, it can be repeated to compute further regions. When repeating the steps, it will ignore historical cases that belong to regions that have already been computed. It will thus choose a historical case that has not yet been explored and only add historical cases to the current region that have not yet been explored. In this way, the method is able to explore the whole space of historical cases and determine a region for each of them. In the end, the method decomposes the whole space of historical cases into regions, and it will return those regions that are within the specified density range. Each historical case will thus be classified into belonging to a region below, within, or above the specified range.

It should be noted that the growth process of a region is non-deterministic. As far as the growth of regions having the minimal volume is concerned, the non-determinism only impacts the way the whole space of historical cases is decomposed into regions, but it will not impact the way the historical cases are classified. As far as the growth of seed regions is concerned, those seed regions may be attributed to regions differing in the classification. As such, there is some non-determinism in the resulting classification, but as the seed regions are small in size, this should only concern a few of the historical cases.

The system for identifying regions of historical data within a frequency density range is a key element of disclosed embodiments. This region detector takes several inputs into account, namely a set of rules, a set of historical cases decided by these rules (together with the timestamps of the decisions), and a frequency density range.

Each historical case is characterized by a case, a decision made for this case, a rule that has made this decision, a time period, and a frequency. The historical case includes all those occurrences of this case during the time period that have been decided by the rule. The frequency of the historical case corresponds to the number of those occurrences. If the performance analysis is performed in a time-agnostic way, all historical cases will have the same time period, namely the complete period over which the analysis has been carried out. In some embodiments of the invention, the analysis may also be carried out in a time-dependent manner.

In those embodiments, the time axis is partitioned into different time intervals and each historical case will concern only a single such time interval, meaning that there may be multiple historical cases for the same case which differ in their time periods.

Furthermore, the system uses several functions and constraints, which may be supplied as input. This includes a function for computing the frequency density of a region, a function for computing a minimal volume for a region (i.e., a volume that needs to be reached in order to compute a meaningful density), and a constraint on the form of the regions. If these functions and constraints are not provided as input, the system uses default versions of these functions and constraints. While the regions in graph 400 are shown as rectangles, in general, the regions can be polygon shaped, or other complex shapes that can be associated with a relationship determined by a rule. Thus, embodiments may include one or more polygon regions and/or rectangle regions.

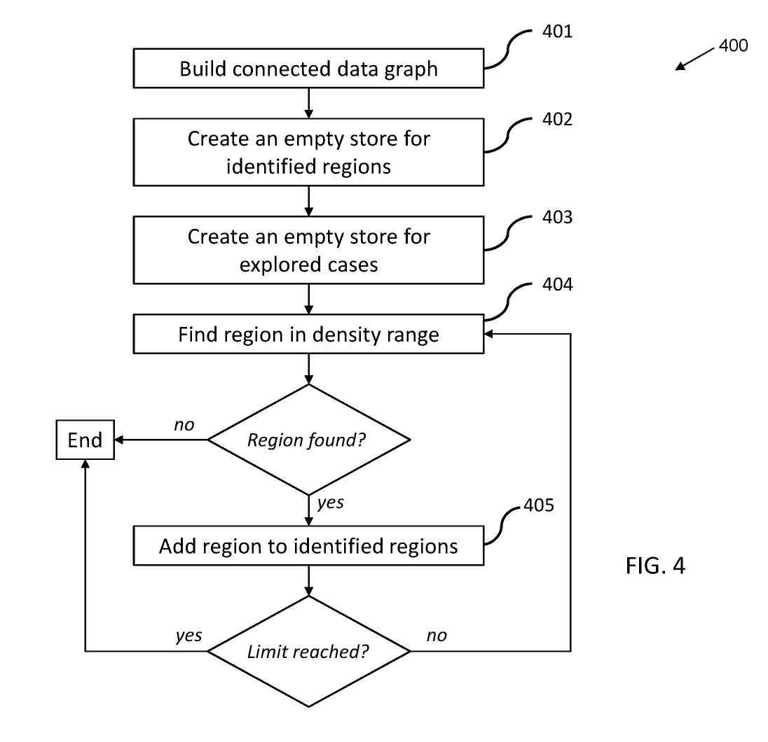

FIG. 4 shows a flowchart 400 indicating process steps for identifying regions in a density range in accordance with embodiments of the present invention. In the first step 401, the system connects the historical cases and builds a connected data graph. This step will be described in more detail below. Step 402 creates an initially empty store which will receive the identified regions of cases within the specified density range. The regions in this store will be represented in intensional form in terms of a conjunction of logical tests as in the examples given above. Step 403 creates a second store which will receive the explored historical cases. Again this store is empty initially. In step 404, the method tries to compute a region of historical, but yet unexplored, cases that are within the specified density range. If the step is able to find a region, step 405 adds this region to the store of identified regions within the specified density range. The method then checks whether a given limit has been reached. Limits may, for example, be time limits or a limit on the number of regions to be found. If no limit has been reached, the method repeats all steps starting from step 404. However, if in step 404 a region has not been found within the specified density range or a limit has been reached, the method terminates while returning all identified regions in the store of identified regions.

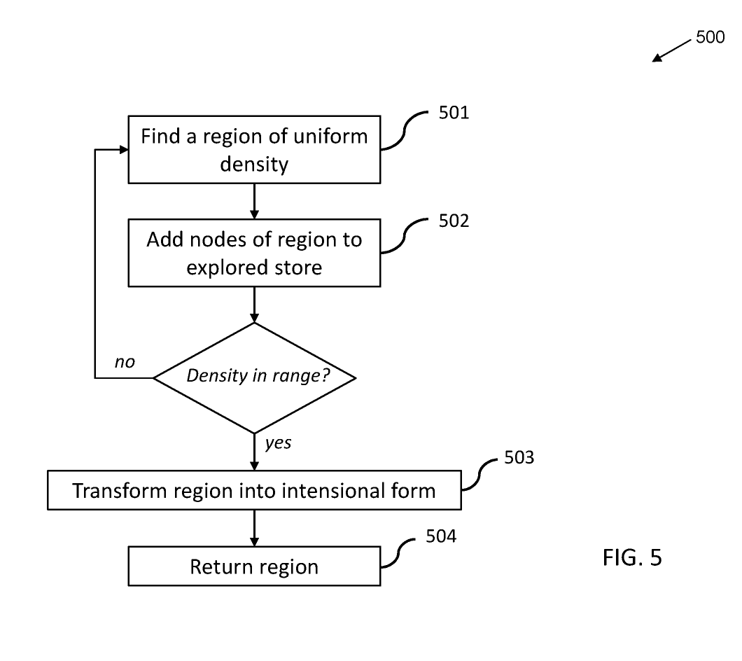

FIG. 5 shows a flowchart 500 illustrating process steps for finding a region in a density range in accordance with embodiments of the present invention. This process may be used in step 404 (FIG. 4). Embodiments are supplied with the connected data graph and a frequency density range. Furthermore, they have access to the store of explored nodes. In step 501, the region finder determines a region of uniform density (see FIG. 3). The density of this region may be within the given density range, below this range, or above this range. Step 502 adds the nodes contained in this region to the store of explored regions. This ensures that the nodes will not be part of future results obtained by re-executing step 501. Step 503 checks whether the density of the detected region is within the specified range. If no, the steps of the method starting from step 501 are repeated. If yes, a region within the specified density range has been found. This region is described in extensional form in terms of a set of connected nodes. This extensional form cannot directly be used to modify the existing rules. Step 503 therefore translates the extensional description of the region into intensional descriptions (i.e., a conjunction of logical conditions over case attributes).

This translation depends on the given constraint on the form of a region. This constraint has a method for doing such a translation. For example, a constraint imposing that regions are axes-parallel rectangular blocks may compute the bounding box of the given sets of nodes and create a description of this bounding box in terms of a conjunction of range membership conditions, namely one for each dimension.

The region builder (step 501) determines a region of uniform density by following the synthetic region growth approach described before. It works with a current region represented by a set of connected nodes. This set of nodes spans a region that satisfies the given region constraint (such as no-hole-in-region constraint or axes-parallel rectangular block constraint). Initially, the set of nodes is initialized by some unexplored node. The region builder then gradually grows the region by adding a node in each step. The growth is achieved in two phases.

In the first phase, the region does not have a sufficient volume to compute a meaningful density and is considered a seed region. The minimal volume may depend on various parameters such as the total number of historical cases, the total number of rules, and is computed by a volume threshold function that takes those parameters as input.

In the second phase, the region exceeds the minimal volume for evaluating the density and its growth needs to stay below, within, or above the specified density range. The second phase stops if the region cannot be grown any more without changing its density range. Growth is also limited by the border edges, as the current region cannot grow across the border edges.

Several notions are needed to explain a single growth step. In each growth step, several candidates are determined and evaluated according to different criteria. A candidate is a node that is connected to one of the nodes of the current region. It is not connected to the current region via a border edge. The growth of the current region is achieved by adding a best candidate to it. In embodiments, one criterion is that this addition must not change the density range of the region.

As the current region needs to meet the given constraint on its form, adding certain candidates may violate this constraint. For example, if the regions are axes-parallel rectangular blocks, the current region will be the bounding box of the current node set. Adding a candidate to the current node set will increase the bounding box. The increased bounding box may contain other nodes, which need to be included into the enlarged node set as well. That is, adding a candidate to the current node set may require the addition of further nodes to the current node set. Those nodes are referred to as derived nodes of the candidate.

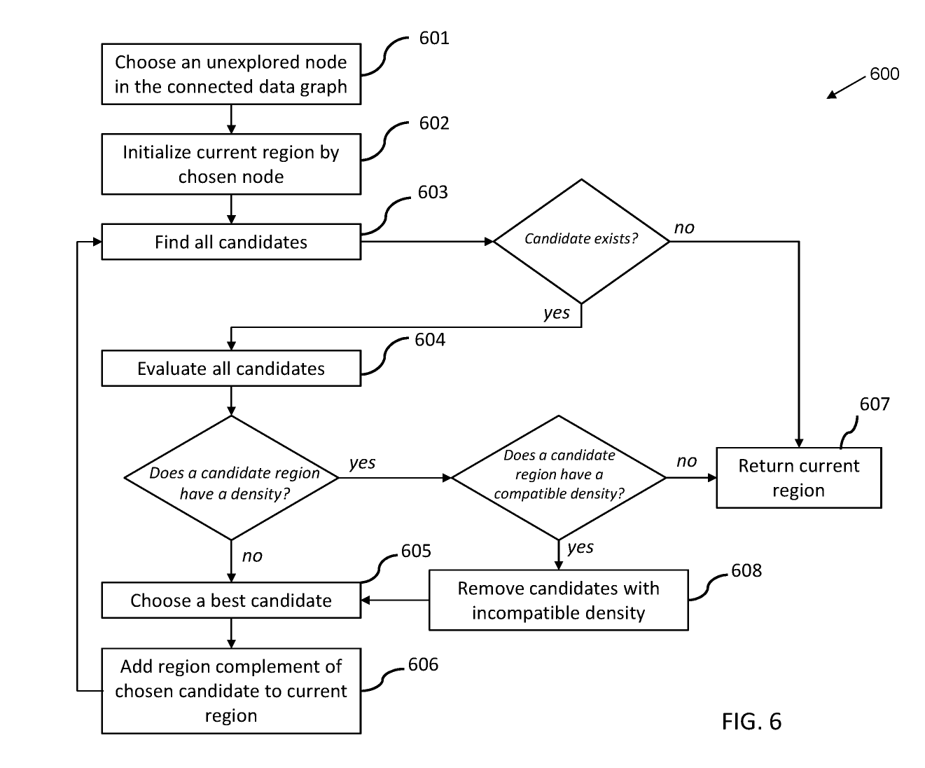

FIG. 6 shows a flowchart for computing a region of uniform density in accordance with embodiments of the present invention. The steps in flowchart 600 may be used in step 501 of FIG. 5. This region builder is supplied with the connected data graph and a frequency density range. Furthermore, it has access to the store of explored nodes. In step 601, the region builder chooses an unexplored node in the connected data graph and, in step 602, uses it to initialize the current region by this node.

In step 603, the region builder collects all candidates (i.e., all nodes of the connected data graph that are unexplored, do not belong to the current region, but are connected to some node of the current region by a non-border edge). If no candidate exists, the method proceeds to step 607 and returns the current region. Otherwise, the region builder evaluates each of the candidates in step 604. The evaluation step will be described in further detail below. The evaluation results into numerical scores of the candidates for each of the given evaluation criteria. Step 604 also computes the derived nodes, the region complement, and the candidate region of each candidate.

If none of the candidate regions exceeds the minimal volume needed for a meaningful density, then the current region does not exceed this minimal volume either, meaning that it is a seed region. As none of candidates reaches the minimal volume, any of the candidates may be selected.

In step 605, the region builder chooses a best candidate (i.e., a candidate that is not dominated by any other candidate according to the evaluation criteria). Step 606 adds the derived nodes of the chosen candidate to the current region. The current region thus is increased by the region complement of this candidate. Once this addition is done, the region builder repeats all steps from step 603 on for the enlarged current region.

If some of the candidate regions exceed the minimal volume needed for a meaningful density, the region builder checks whether some of the candidate regions have a density compatible with that of the current region. If yes, then either the current region is a seed region and the candidate region is not a seed region, or both the current region and candidate regions are below, within, or above the specified density range. In this case, the region builder removes all candidates with incompatible density at step 608 before proceeding to steps 605 and 606. This means, the region builder will pick a best candidate among those candidates that have a compatible density.

As a consequence, the current region either reaches the minimal volume in this step and thus gains a meaningful density or stays in its density range. After the step 606 has increased the current region, the region builder repeats all steps from step 603 on. If none of the candidates has a compatible density, the region cannot grow anymore. Step 607 returns the current region in that case. The method can be understood as a particular graph exploration method that uses a set of closed nodes (the explored nodes), and a set of open nodes (the candidates). However, it should be noted that a standard graph exploration method adds a single node in each step, whether the method described above adds all derived nodes of the chosen candidate in order to meet the given constraint about the form of the region. Moreover, the method does not use a global evaluation criterion, but local evaluation criteria.

Step 604 performs an evaluation of each candidate. In order to evaluate a candidate, the system computes the derived nodes of the candidate and the candidate region. It then uses this information to compute the density of the candidate region. Once these characteristics of the candidate have been determined, the system calculates the numerical scores of the candidate for each of the given criteria.

The set of derived nodes of a candidate is the set of all nodes that need to be added to the current region in order to meet the constraint about the form of the region in case the candidate is added to the current region. This set includes the candidate itself. Moreover, the derived nodes are connected to the current region.

The method for computing the derived nodes of a candidate and the candidate region uses the constraint on the form of the region. This constraint is represented by a predicate that tests whether a node necessarily belongs to a region that is spanned by a set of nodes. For example, a constraint for axes-parallel rectangular blocks checks whether a node belongs to the bounding box of a set of nodes. The bounding box can easily be computed by taking the minimal and maximal values of all nodes in the set in each dimension.

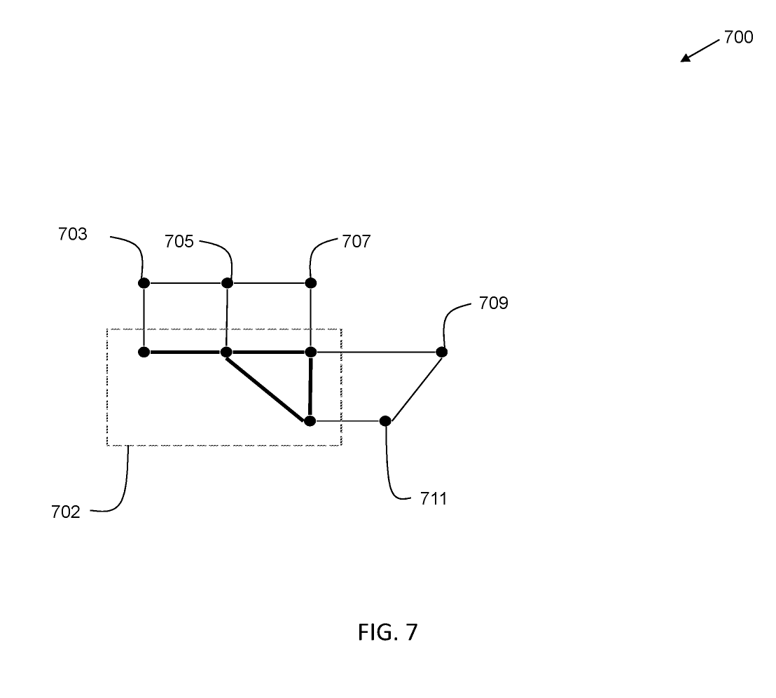

FIG. 7 shows an example 700 of derived nodes during region manipulation. The set of derived nodes of a candidate is the minimal set of nodes that will be added to the current region 702 if the candidate is added to the current region. For example, node 709 (candidate 1) has one derived node 711, as adding candidate 1 to the current region will increase the bounding box of the current region at its right side, thus including this derived node as well. Similarly, node 707 (candidate 2) has two derived nodes (703 and 705) as adding candidate 2 to the current region will increase the bounding box of the current region at its top side, thus including these two derived nodes as well.

The region complement of a candidate is the region that will be added to the current region if the candidate is added to the current region. The candidate region is the union of the current region and the region complement of the candidate. If the candidate region exceeds the minimal volume for a meaningful density, then the density of the candidate region will impact the evaluation of the candidate. A candidate region has a density compatible with the current region if one of the following conditions is satisfied:
1. The current region does not have meaningful density.
2. The current region and the candidate region are both below the specified density range.
3. The current region and the candidate region meet both the specified density range.
4. The current region and the candidate region are both above the specified density range.

Each candidate is evaluated according to different criteria which are determining numeric scores. The criteria may, for instance, include minimizing the volume of the region complement or minimizing the variation of the density between the current region and the candidate region.

The criteria may also include information regarding the neighbors of the candidate or the temporal distribution of the occurrences of the candidate. These criteria are controlling the growth process and may be used to encode heuristics. A best candidate is a candidate that is not dominated by any other candidate according to all criteria (i.e., there is no other candidate that is at least as good as the candidate on all criteria and strictly better than the candidate on some criteria.

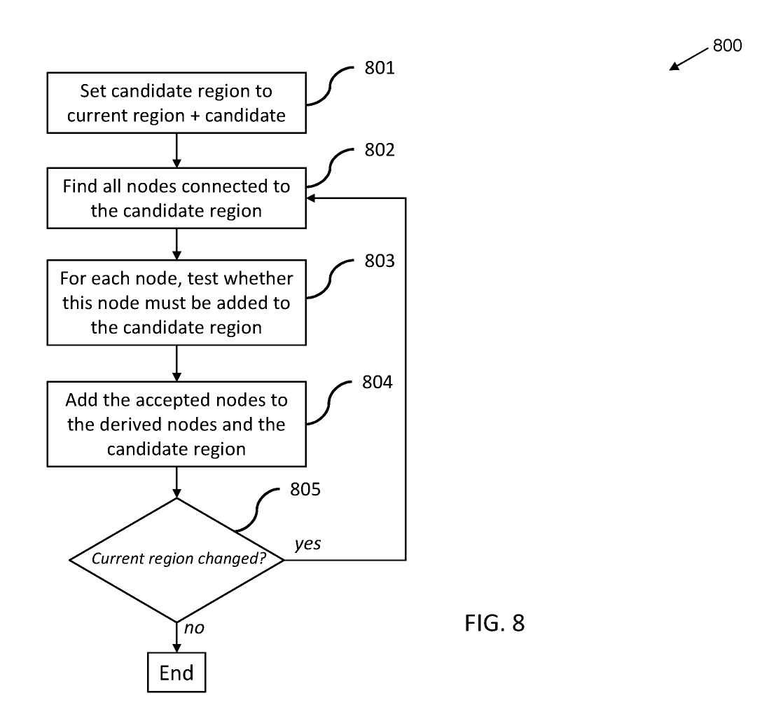

FIG. 8 shows a flowchart 800 illustrating process steps for computing the derived nodes of a candidate and the candidate region. This method is supplied with a candidate, the current region, and the connected data graph. Step 801 sets the candidate region to the current region. It then adds the candidate to this candidate region, as well as to the set of derived nodes (the latter is empty initially). Step 802 finds nodes connected to the candidate region. This can include determining all nodes that are unexplored and do not belong to the candidate region, but are connected to some node of the candidate region by a non-border edge. Step 803 examines each of these nodes and determines which nodes satisfy the constraint about the form of the candidate region. For this purpose, the predicate of the constraint is applied to the node under examination, as well as to the nodes of the candidate region. If one of these predicate applications evaluates as true, the node has been accepted for inclusion into the candidate region. Step 804 adds the accepted nodes to the derived nodes and to the candidate region. If the set of accepted nodes is not empty, step 804 has modified the candidate region. As the new region may require the inclusion of further nodes, the method repeats its steps from step 802 on. At step 805, an evaluation is made to determine if the current region has changed. If yes, the process repeats from step 802. If no, after step 805, the process terminates and returns the candidate region and the set of derived nodes.

Once the candidate region and the derived nodes of a candidate are known, they can be used to compute the density of the candidate region. The density of a region is defined by the frequency of historical cases in the region divided by the volume of the region. The frequency can be obtained by the set of nodes that is spanning the candidate region. Each of these nodes corresponds to a historical case, which has a frequency. It is therefore sufficient to sum the frequencies of all these nodes in order to compute the frequency of the region.

As the candidate region needs to satisfy the constraint on the form of the region, its volume can be computed with the help of this constraint. It is therefore possible to consider that a constraint on the form of a region furthermore has a function for computing the volume of a region that is spanned by a set of nodes. This function takes the set of nodes as arguments and returns the volume. For example, a constraint for axes-parallel rectangular blocks returns the volume (or area) of the bounding box of the given set of nodes. The method thus computes the volume of the candidate region by applying the volume function of the constraint to the set of nodes of the candidate region.

Once the frequency and the volume of the candidate region have been determined, the density of the candidate region is computed as well. Now all the characteristics of the candidate region are known and it is possible to determine the numerical scores of the candidate by applying the given criteria to those characteristics.

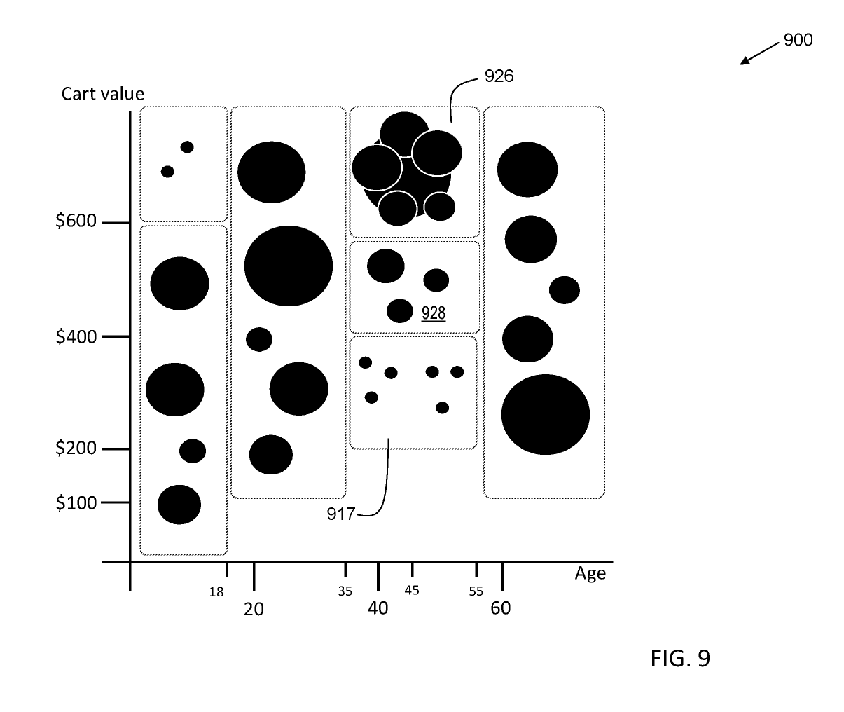

FIG. 9 shows an exemplary graph 900 of identified candidates for rule separation and consolidation. With reference again to graph 300 of FIG. 3, region 316 of FIG. 3 has been divided into region 926 and region 928 of FIG. 9. Thus, while graph 300 used a single rule, graph 900 uses two rules. A rule associated with region 926 could be expressed as:
a. the customer age is at least 35 and
b. the customer age is less than 55 and
c. the cart value is at least $590

Similarly, a rule associated with region 928 could be expressed as:
a. the customer age is at least 35 and
b. the customer age is less than 55 and
c. the cart value is at least $400 and
d. the cart value is less than $590

With reference again to graph 300 of FIG. 3, region 312 and region 314 of FIG. 3 have been combined into region 917 of FIG. 9. Thus, while graph 300 used two rules, graph 900 uses a single rule.

A rule associated with region 917 could be expressed as:
a. the customer age is at least 35 and
b. the customer age is less than 55 and
c. the cart value is at least $200 and
d. the cart value is less than $400

Thus, graph 900 provides a visual indication of combined and separated rules based on analysis using frequency density.

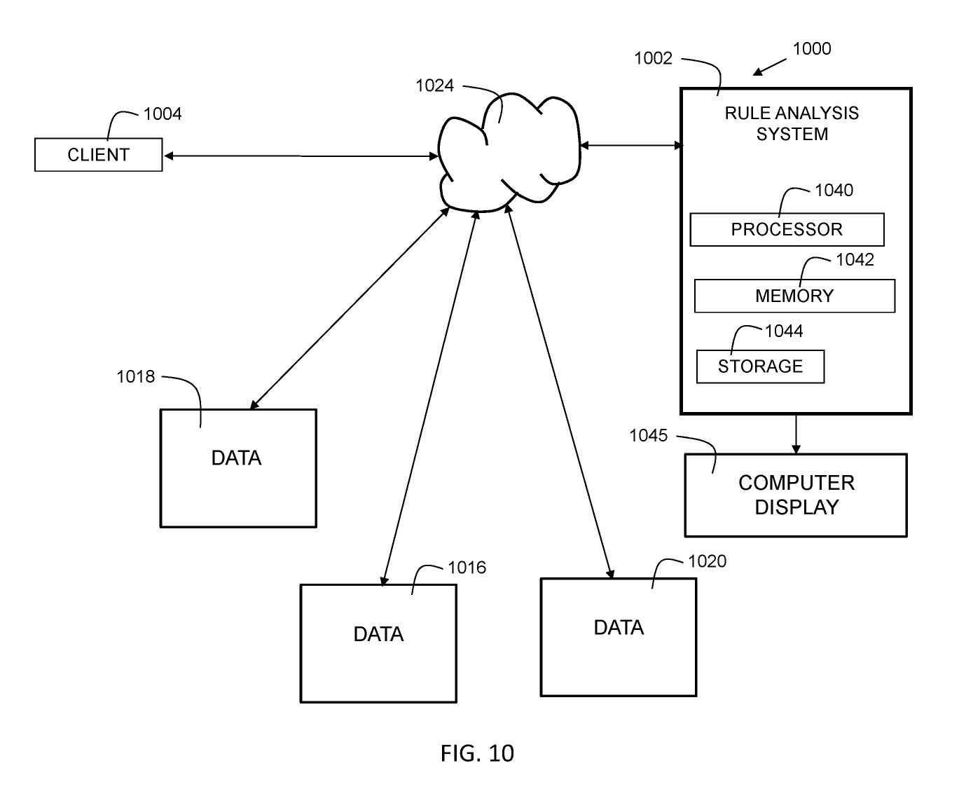

FIG. 10 is a diagram of an environment 1000 showing a system in accordance with embodiments of the present invention. Rule performance analysis system 1002 may be an electronic computing device that includes processor 1040, memory 1042, and storage 1044. Rule performance analysis system 1002 is an electronic device that includes processor 1040, memory 1042, and storage 1044. Rule performance analysis system 1002 is in communication with network 1024. Memory 1042 may include dynamic random access memory (DRAM), static random access memory (SRAM), magnetic storage, and/or a read only memory such as flash, EEPROM, optical storage, or other suitable memory. Memory 1042 includes instructions for executing steps in accordance with embodiments of the present invention. In embodiments, storage 1044 may include one or more magnetic storage devices such as hard disk drives (HDDs). Storage 1044 may include one or more solid state drives (SSDs). Any other storage device may be included instead of, or in addition to, those disclosed herein. Network 1024 may be the Internet, a wide area network, a local area network, a cloud computing network, an intra-enterprise network, or any other suitable network or combination thereof. The rules analysis system 1002 may obtain data, such as customer behavior data from one or more data servers, indicated as 1016, 1018, and 1020. In embodiments, the rules analysis system 1002 may provide results to a client device 1004 via network 1024. In embodiments, the results are provided via HTML pages served to client device 1004 via HTTP and TCP/IP or other suitable protocols.

In embodiments, rule performance analysis system 1002 performs the following steps: Data for a plurality of events is obtained. A rule set for the plurality of events is obtained, where the rule set comprises a plurality of rules. Determined regions are computed based on the rules within the rule set. Frequency data for the plurality of events is computed. An indication of frequency density for each region is provided. In embodiments, determined regions may be represented in extensional forms (list of data points, where each data point represents a case) or in intensional form (conjunction of logical conditions). Thus, in embodiments, the rule performance analysis system 1002 analyzes both rules and corresponding data to determine a measure of the effectiveness of previously established rules. The system 1002 can provide recommendations based on the rule analysis and render the recommendations on connected computer display 1045.

As can now be appreciated, disclosed embodiments provide improvements in rule analysis, and provide techniques for determining the effectiveness of rules using representations of frequency density within regions that correlate to the rules. In this way, a business analyst can quickly discern process improvements that can be made by splitting up or consolidating various rules. The rules of the rule set can be implemented in a computer-based business process management system. The rules can be specific rules that have been created for and are executed within a computer system for managing complex business processes.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

What is claimed is:

1. A computer-implemented method for analyzing rule-based decision policies comprising:
obtaining data for a plurality of events;
obtaining a rule set for the plurality of events, wherein the rule set comprises a plurality of rules embodied in a computer-based business management system, wherein the computer-based business management system includes a processor;
computing frequency data with the processor for the plurality of events based on the rule set; and
computing regions based on the rules within the rule set, wherein each region corresponds to a subset of the plurality of events;
providing a recommendation of one or more rule modifications based on the frequency data; and
rendering the recommendation on a computer display.

2. The method of claim 1, further comprising:
determining a frequency density range for the plurality of events based on the frequency data; and
wherein computing regions based on the rules within the rule set is based on the frequency density range.

3. The method of claim 1, wherein computing the region comprises computing a rectangle.

4. The method of claim 1, further comprising identifying candidates for rule consolidation.

5. The method of claim 1, further comprising identifying candidates for rule separation.

6. The method of claim 1, further comprising identifying a region in a specified density range.

7. The method of claim 1, further comprising identifying a region of a uniform frequency density.

8. An electronic computing device for analyzing rule-based decision policies, comprising:
a processor;
a memory coupled to the processor, the memory containing instructions, that when executed by the processor, perform the steps of:
obtaining data for a plurality of events;
obtaining a rule set for the plurality of events, wherein the rule set comprises a plurality of rules;
computing frequency data for the plurality of events based on the rule set;
determining a frequency density range for the plurality of events based on the frequency data;
computing regions based on the rules within the rule set, wherein each region corresponds to a subset of the plurality of events;
providing a recommendation of one or more rule modifications based on the frequency data; and
rendering the recommendation on a computer display.

9. The electronic computing device of claim 8, wherein the memory further contains instructions, that when executed by the processor, performs the step of computing the region by computing a polygon.

10. The electronic computing device of claim 8, wherein the memory further contains instructions, that when executed by the processor, performs the step of computing the region by computing a rectangle.

11. The electronic computing device of claim 8, wherein the memory further contains instructions, that when executed by the processor, performs the step of identifying candidates for rule consolidation.

12. The electronic computing device of claim 8, wherein the memory further contains instructions, that when executed by the processor, performs the step of identifying candidates for rule separation.

13. The electronic computing device of claim 8, wherein the memory further contains instructions, that when executed by the processor, performs the step of comprising identifying a region in a specified density range.

14. The electronic computing device of claim 8, wherein the memory further contains instructions, that when executed by the processor, performs the step of identifying a region of a uniform frequency density.

15. A computer program product for analyzing rule-based decision policies on an electronic computing device, the electronic computing device comprising a computer readable storage medium having program instructions embodied therewith, the program instructions executable by a processor to cause the electronic computing device to:
obtain data for a plurality of events;
obtain a rule set for the plurality of events, wherein the rule set comprises a plurality of rules;
compute frequency data for the plurality of events based on the rule set;
determine a frequency density range for the plurality of events based on the frequency data;
compute regions based on the rules within the rule set, wherein each region corresponds to a subset of the plurality of events;
provide a recommendation of one or more rule modifications based on the frequency data; and
render the recommendation on a computer display.

16. The computer program product of claim 15, further comprising program instructions executable by the processor to cause the electronic computing device to compute a polygon region.

17. The computer program product of claim 15, further comprising program instructions executable by the processor to cause the electronic computing device to compute a rectangle region.

18. The computer program product of claim 15, further comprising program instructions executable by the processor to cause the electronic computing device to identify candidates for rule consolidation.

19. The computer program product of claim 15, further comprising program instructions executable by the processor to cause the electronic computing device to identify candidates for rule separation.

20. The computer program product of claim 15, further comprising program instructions executable by the processor to cause the electronic computing device to identify a region of a uniform frequency density.
